(19) United States
(12) Patent Application Publication
(10) Pub. No.: US 2008/0028141 A1
(43) Pub. Date: Jan. 31, 2008

(54) System and Method for Implementing Hard Disk Drive Data Clear and Purge

(76) Inventors: Matthew J. Kalos, Tucson, AZ (US); Robert A. Kubo, Tucson, AZ (US); Juan A. Yanes, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/459,842

(22) Filed: Jul. 25, 2006

(51) Int. Cl. G06F 12/00

(52) U.S. Cl. 711/112; 711/159

(57) ABSTRACT

A method, system, and computer-usable medium for implementing a hard disk drive data clear and purge. In a preferred embodiment of the present invention, a processor sends a predetermined data pattern to be written to a hard disk drive and issues a command for the hard disk drive to write the predetermined data pattern to an entire surface of the hard disk drive. The hard disk drive updates the entire surface with the predetermined data pattern and the processor verifies that the entire surface of the hard disk drive is updated with the predetermined data pattern.

### BACKGROUND OF THE INVENTION

1. Technical Field

The present invention relates in general to the field of data processing systems. More particularly, the present invention relates to the field of data storage within data processing systems. Still more particularly, the present invention relates to a system and method for implementing a hard disk drive data clear and purge.

2. Description of the Related Art

The current regulatory environment introduces increased privacy concerns that that information be tightly controlled and protected. As the role of information becomes more critical, the challenges of managing and maintaining information increase. Unfortunately, there are many regulations and different standards by which the management and record keeping of data erasure are required. The documented requirements for data erase for hard disk drive magnetic media can generally be described as requiring that the media that the original data was stored upon be placed in a condition so that the original data cannot be recovered.

The generally accepted method for achieving these requirements is to update the addressable data blocks of the media with specific data patterns in a specific sequence that leaves the media in a known state (e.g., data pattern). Existing methods required that some system-level entity (e.g., a host processor-level device) write the specified data patterns to the hard disk device's addressable areas and verify that the data patterns have been applied. The requirement of a system-level entity to perform the write responsibilities is extremely inefficient because this requires that the system CPU complex and the device interface network resources be utilized of the transport of all the data to the device media. Therefore, there is a need for a system and method for addressing the aforementioned limitations of the prior art.

### SUMMARY OF THE INVENTION

The present invention includes a method, system, and computer-usable medium for implementing a hard disk drive data clear and purge. In a preferred embodiment of the present invention, a processor sends a predetermined data pattern to be written to a hard disk drive and issues a command for the hard disk drive to write the predetermined data pattern to an entire surface of the hard disk drive. The hard disk drive updates the entire surface with the predetermined data pattern and the processor verifies that the entire surface of the hard disk drive is updated with the predetermined data pattern.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 is a block diagram illustrating an exemplary data processing system in which a preferred embodiment of the present invention may be implemented; and

FIG. 2 is a high-level logical flowchart diagram depicting an exemplary method for implementing hard disk drive data clear and purge according to a preferred embodiment of the present invention.

### DETAILED DESCRIPTION OF A PREFERRED EMBODIMENT

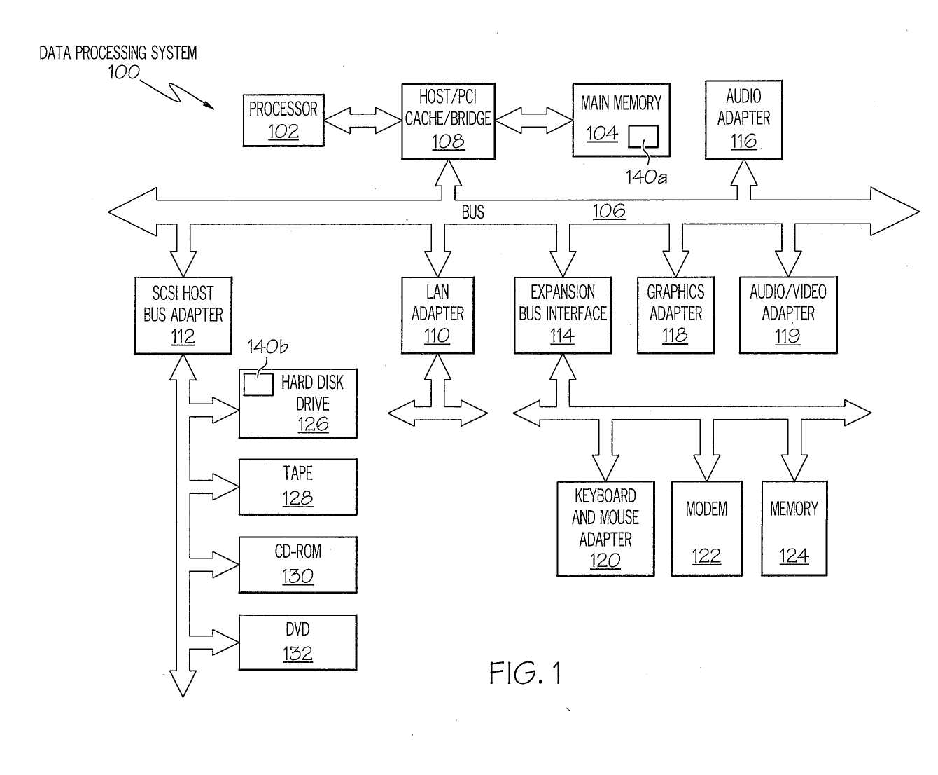

With reference now to the figures, and in particular with reference to FIG. 1, there is a block diagram of data processing system 100 in which a preferred embodiment of the present invention may be implemented. Data processing system 100 employs a peripheral component interconnect (PCI) local bus architecture. Although the depicted example employs a PCI bus, other bus architectures, such as Micro Channel and ISA may be used. Processor 102 and main memory 104 are connected to PCI local bus 106 through PCI bridge 108. PCI bridge 108 may also include an integrated memory controller and cache memory for processor 102. Additional connections to PCI local bus 106 may be made through direct component interconnection or through add-on boards. In the depicted example, local area network (LAN) adapter 110, SCSI host bus adapter 112, and expansion bus interface 114 are connected to PCI local bus 106 by direct component connection. In contrast, audio adapter 116, graphics adapter 118, and audio/video adapter (A/V) 119 are connected to PCI local bus 106 by add-in boards inserted into expansion slots. Expansion bus interface 114 provides a connection for a keyboard and mouse adapter 120, modem 122, and additional memory 124. In the depicted example, SCSI host bus adapter 126 provides a connection for hard disk drive 126, tape drive 128, CD-ROM drive 130, and digital video disc read only memory drive (DVD-ROM) 132. Typical PCI local bus implementations will support three or four PCI expansion slots or add-in connectors.

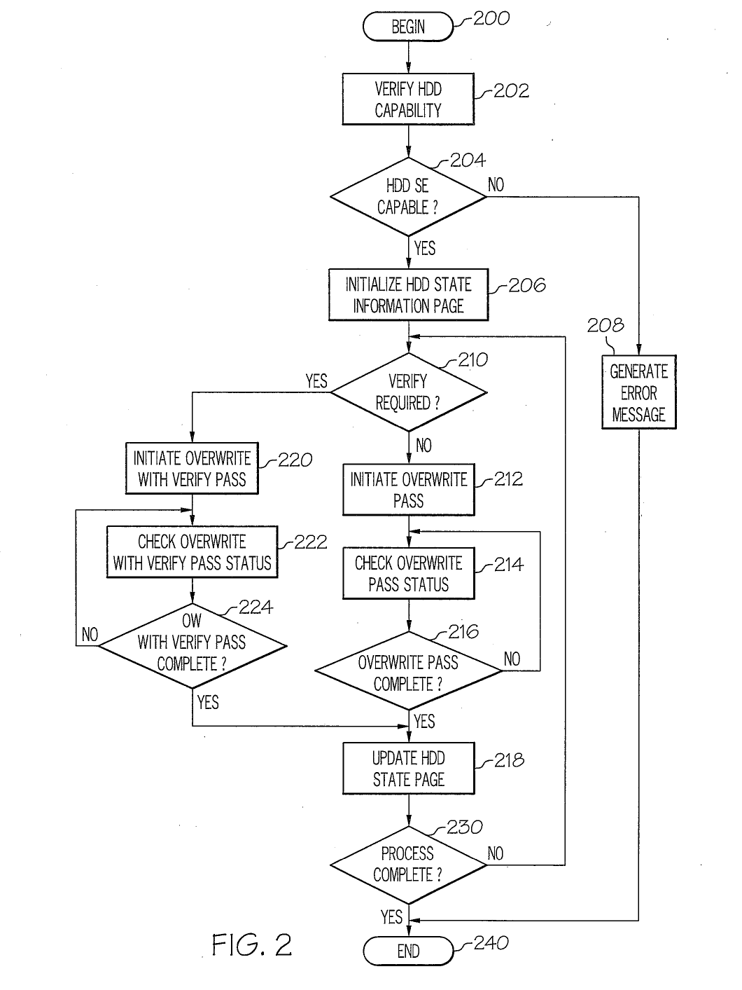

As an operating system runs on processor 102 and is used to coordinate and provide control of various components within data processing system 100 in FIG. 1. The operating system may be a commercially available operating system, such as Linux. An object oriented programming system, such as Java, may run in conjunction with the operating system, providing calls to the operating system from Java programs or applications executing on data processing system 100. Instructions for the operating system, the object-oriented operating system, and applications and programs are located in a storage device, such as hard disk drive 126, and may be loaded into main memory 104 for execution by processor 102. Also included within main memory 104 and hard disk drive 126 are hard disk drive state tables 140a-b, described herein in more detail in conjunction with FIG. 2.

Those of ordinary skill in the art will appreciate that the hardware in FIG. 1 may vary depending on the implementation. For example, other peripheral devices, such as optical disk drives and the like, may be used in addition to or in place of the hardware depicted in FIG. 1. The depicted example is not meant to imply architectural limitations with respect to the present invention. For example, the processes of the present invention may be applied to multiprocessor data processing systems.

FIG. 2 is a high-level logical flowchart diagram depicting an exemplary method for implementing hard disk drive data clear and purge according to a preferred embodiment of the present invention. The process begins at step 200 and continues to step 202, which illustrates a check being to determine if hard disk drive 126 has the capability to perform the operations required to support a secure erase process. In a preferred embodiment of the present invention, the check is made to hard disk drive 126 by processor 102 via SCSI host bus adapter 112. The results of the check are then evaluated, as illustrated in step 204.

If hard disk drive 126 is not capable of supporting the secure erase process, an error message is generated and the process ends, as depicted in steps 208 and 240. If the device is found to support the secure erase capability, the process continues to step 206, which illustrates processor 102 initializing hard disk drive state tables 140a-b to a known state.

The process continues to step 210, which illustrates processor 102 evaluating whether a verification of the data pattern that was written during the overwrite pass is required. If a verification is not required, the process continues to step 212, which illustrates processor 102 initiating an overwrite pass. The overwrite pass is initiated by sending a command to hard disk drive 126 to write a specified data pattern to all user-accessible sectors including those that have been reallocated due to media errors. The process continues to step 214, which depicts processor 102 via SCSI host bus adapter 112 querying hard disk drive 126 to determine the status of the overwrite process, at specified time interval T. If the overwrite pass has been completed, the process proceeds to step 218, which illustrates processor 102 updating hard disk drive state tables 140a-b with the results of the completed overwrite pass.

Returning to step 210, if processor 102 determines that the verification of the data pattern that was written during the overwrite pass is required, then the process proceeds to step 220, which illustrates processor 102 initiating an overwrite with verification pass. The overwrite pass with verification is initiated by processor 102 via SCSI host bus adapter 112 by sending a command to hard disk drive 126 to write a specified data pattern to all user-accessible sectors, include those sectors that have been allocated due to media errors, followed by a verification read of all of the updated sectors to validate that the applied data pattern is present in all of the sectors written.

The process then proceeds to step 222, which depicts processor 102 via SCSI host bus adapter 112 querying hard disk drive 126 to determine the status of the overwrite with verify process. The process continues to step 224, which illustrates processor 102 evaluating the results of the status query to determine if the overwrite pass with verify has been completed. If the overwrite with verification pass has not been completed, the process returns to step 222 and completes a new wait interval of time T. If the overwrite pass with verify has been completed, the process continues to step 218, which illustrates processor 102 updating hard disk drive state tables 140a-b with the results of the completed overwrite with verify pass.

The process proceeds to step 230, which illustrates processor 102 determining if the secure erase process of hard disk drive 126 has been completed. If the secure erase process has not been completed, the process returns to step 210 and continues in an iterative fashion. If the secure erase process has been completed, the process ends, as illustrated at step 240.

As discussed, the present invention includes a method, system, and computer-usable medium for implementing a hard disk drive data clear and purge. In a preferred embodiment of the present invention, a processor sends a predetermined data pattern to be written to a hard disk drive and issues a command for the hard disk drive to write the predetermined data pattern to an entire surface of the hard disk drive. The hard disk drive updates the entire surface with the predetermined data pattern and the processor verifies that the entire surface of the hard disk drive is updated with the predetermined data pattern.

It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to Random Access Memory (RAM), and communication media, such as computer and telephone networks, including Ethernet, the Internet, wireless networks, and like network systems. It should be understood, therefore, that such signal-bearing media when carrying or encoding computer readable instructions that direct method functions in the present invention represent alternative embodiments of the present invention. Further, it is understood that the present invention may be implemented by as a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention. Furthermore, as utilized in the specification and the appended claims, the term “computer” or “system” or “computer system” or “computing device” includes any data processing system including, but not limited to, personal computers, servers, workstations, network computers, main frame computers, routers, switches, personal digital assistants (PDAs), telephones, and any other system capable of processing, transmitting, receiving, capturing, and/or storing data.

What is claimed is:

1. A computer-implementable method for clearing and purging a hard disk drive, said computer-implementable method comprising:
sending a predetermined data pattern to be written to a hard disk drive;
issuing a command for said hard disk drive to write said predetermined data pattern to an entire surface of said hard disk drive;
updating said entire surface of said hard drive with said predetermined data pattern; and
verifying that said entire surface of said hard disk drive is updated with said predetermined data pattern.

2. The computer-implementable method according to claim 1, further comprising:
verifying said hard disk drive is a secure erase capable device.

3. The computer-implementable method according to claim 1, further comprising:
initializing a plurality of hard disk drive state tables to a known state.

4. The computer-implementable method according to claim 1, further comprising:
in response to determining a verification of said predetermined data pattern is not required, initiating an overwrite pass by sending a command to said hard disk drive to write said predetermined data pattern to all user-accessible sectors including those that have been reallocated due to media errors.

5. The computer-implementable method according to claim 1, further comprising:
in response to determining a verification of said predetermined data pattern is required, initiating an overwrite pass with verification by sending a command to said hard disk drive to write said predetermined data pattern to all user-accessible sectors including those that have been reallocated due to media errors followed by a verification read of all updated sectors to validate said predetermined data patter is present in all written sectors.

6. The computer-implementable method according to claim 1, further comprising:
refreshing drive state information after said updating said entire surface of said hard drive with said predetermined data pattern.

7. A system comprising:
a processor;
a databus coupled to said processor;
a hard disk drive; and
a computer-usable medium embodying computer program code, said computer-usable medium being coupled to said databus, said computer program code comprising instructions executable by said processor and configured for:
sending a predetermined data pattern to be written to a hard disk drive;
issuing a command for said hard disk drive to write said predetermined data pattern to an entire surface of said hard disk drive;
updating said entire surface of said hard drive with said predetermined data pattern; and
verifying that said entire surface of said hard disk drive is updated with said predetermined data pattern.

8. The system according to claim 7, wherein said instructions are further configured for:
verifying said hard disk drive is a secure erase capable device.

9. The system according to claim 7, wherein said instructions are further configured for:
initializing a plurality of hard disk drive state tables to a known state.

10. The system according to claim 7, wherein said instructions are further configured for:
in response to determining a verification of said predetermined data pattern is not required, initialing an overwrite pass by sending a command to said hard disk drive to write said predetermined data pattern to all user-accessible sectors including those that have been reallocated due to media errors.

11. The system according to claim 7, wherein said instructions are further configured for:
in response to determining a verification of said predetermined data pattern is required, initiating an overwrite pass with verification by sending a command to said hard disk drive to write said predetermined data pattern to all user-accessible sectors including those that have been reallocated due to media errors followed by a verification read of all updated sectors to validate said predetermined data patter is present in all written sectors.

12. The system according to claim 7, wherein said instructions are further configured for:
refreshing drive state information after said updating said entire surface of said hard drive with said predetermined data pattern.

13. A computer-usable medium embodying computer program code, said computer program code comprising computer-executable instructions configured for:
sending a predetermined data pattern to be written to a hard disk drive;
issuing a command for said hard disk drive to write said predetermined data pattern to an entire surface of said hard disk drive;
updating said entire surface of said hard drive with said predetermined data pattern; and
verifying that said entire surface of said hard disk drive is updated with said predetermined data pattern.

14. The computer-usable medium according to claim 13, wherein said embodied computer program code further comprises computer-executable instructions configured for:
verifying said hard disk drive is a secure erase capable device.

15. The computer-usable medium according to claim 13, wherein said embodied computer program code further comprises computer-executable instructions configured for:
initializing a plurality of hard disk drive state tables to a known state.

16. The computer-usable medium according to claim 13, wherein said embodied computer program code further comprises computer-executable instructions configured for:
in response to determining a verification of said predetermined data pattern is not required, initialing an overwrite pass by sending a command to said hard disk drive to write said predetermined data pattern to all user-accessible sectors including those that have been reallocated due to media errors.

17. The computer-usable medium according to claim 13, wherein said embodied computer program code further comprises computer-executable instructions configured for:
in response to determining a verification of said predetermined data pattern is required, initiating an overwrite pass with verification by sending a command to said hard disk drive to write said predetermined data pattern to all user-accessible sectors including those that have been reallocated due to media errors followed by a verification read of all updated sectors to validate said predetermined data patter is present in all written sectors.

18. The computer-usable medium according to claim 13, wherein said embodied computer program code further comprises computer-executable instructions configured for:
in response to determining a verification of said predetermined data pattern is not required, initialing an overwrite pass by sending a command to said hard disk drive to write said predetermined data pattern to all user-accessible sectors including those that have been reallocated due to media errors.
